(19) United States
(12) Patent Application Publication
(10) Pub. No.: US 2012/0283428 A1
(43) Pub. Date: Nov. 8, 2012

(54) HYALURONIC ACID DERIVATIVE EFFECTIVE AGAINST ATOPIC DERMATITIS, AND METHOD FOR MANUFACTURING SAME

(75) Inventors: Dong Hee Lee, Bansong-dong (KR); Jun Sik Song, Godae-myeon (KR); Ha Na Jung, Buk-gu (KR); Sang Do Cha, Gangseo-gu (KR); Da Yea Lee, Dongjak-gu (KR); Cheol Min Kim, Giheung-gu (KR); Jong Chul Park, Seodaemun-gu (KR)

(73) Assignee: CELLINBIO CO.,LTD, Suwon-si (Gyeonggi-do-province) (KR)

(21) Appl. No.: 13/513,133

(22) PCT Filed: Sep. 13, 2010
(86) PCT No.: PCT/KR2010/006214

§ 371 Date: Jul. 25, 2012

(30) Foreign Application Priority Data
Dec. 1, 2009 (KR) 10-2009-0117962

(51) Int. Cl. C08B 37/08

(52) U.S. Cl. 536/53

(57) ABSTRACT

Disclosed are a hyaluronic acid derivative effective against atopic dermatitis, and a method for manufacturing same. The method for manufacturing the hyaluronic acid derivative of the present invention comprises: a first step of chlorinating ascorbic acid; a second step of producing a tetrabutylamonium hydroxide (TBA) salt of hyaluronic acid; and a third step of conjugating the ascorbic acid chlorinated in the first step and the TBA salt of hyaluronic acid produced in the second step. The hyaluronic acid derivative can effectively decrease the substances causing skin lesions, can contribute toward the remission of atopic disease, and is effective in skin renewal.

### FIELD OF THE INVENTION

The present invention relates to a hyaluronic acid derivative and process thereof, and more particularly, to a hyaluronic acid derivative which is effective for an atopic dermatitis and the likes and is synthesized by conjugating a salt of hyaluronic acid and an ascorbic acid and process thereof.

### BACKGROUND ART

Hyaluronic acid is a kind of a composite polysaccharide consisting of an amino acid and an uronic acid. Concretely, hyaluronic acid is a polymer compound consisting of alternately linked of N-acetylglucosamine and glucuronic acid with a molecular weight of 5,000 to 20,000,000. An exemplary chemical structure of hyaluronic acid is shown in formula I below.

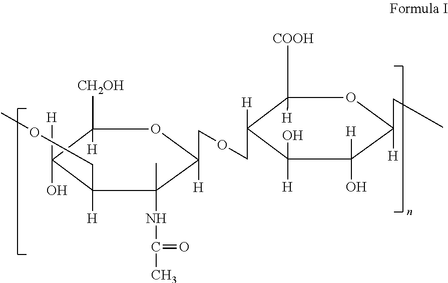

Hyaluronic acid exists in a vitreous body of eyes, an umbilical cord, chicken's comb and the likes. Various hyaluronic acid derivatives including salts of hyaluronic acid have been used as films or gels preventing post-operative adhesions, various plastic aids such as implants against wrinkles and the likes, or implants for treating arthritis. Also, it has been known that such hyaluronic acids are effective for treating skin disorders and regenerating skins

### DETAILED DESCRIPTION OF THE INVENTION

### Technical Solution

An object of the present invention is to provide a new hyaluronic acid derivative that alleviates skin disorders by reducing effectively substances causing skin lesions, regenerates damaged skins and particularly is effective for atopic dermatitis, and process of the hyaluronic acid derivative.

### Technical Effect of the Invention

Hyaluronic acid derivative of the present invention can decrease substances causing skin lesions, alleviate atopic dermatitis and is effective for skin regeneration.

### BRIEF DESCRIPTION OF THE DRAWINGS

FIG. 1 is a diagram showing a process of a hyaluronic acid derivative (CIB09001S) according to an exemplary embodiment of the present invention;

FIG. 2 is a graph showing a measuring result for reducing PGE₂ in cellular level induced by the hyaluronic acid derivative (CIB09001S) according to Example 1 of the present invention;

FIG. 3 is a graph showing a measuring result for reducing TNF-α in cellular level induced by the hyaluronic acid derivative (CIB09001S) according to Example 2 of the present invention;

FIGS. 4 to 6 are graphs showing measuring results for cytotoxicity induced by the hyaluronic acid derivative according to Example 3 of the present invention;

FIG. 7 is a photograph showing mice's ears for treating an atopic dermatitis induced by the hyaluronic acid derivative according to Example 4 of the present invention;

FIG. 8 is a graph showing a measuring result for each mouse's ear thickness according to Example 4 of the present invention;

FIG. 9 is photomicrograph showing mice's skin tissues for skin regeneration induced by the hyaluronic acid derivative according to Example 5 of the present invention; and

FIG. 10 is graph showing a measuring result for skin regeneration induced by the hyaluronic acid derivative according to Example 5 of the present invention.

### BEST MODE OF THE INVENTION

For achieving the object of the present invention, a process of synthesizing a hyaluronic acid derivative according to an exemplary embodiment of the present invention comprises chlorinating an ascorbic acid to obtain a chlorinated ascorbic acid; producing a tetrabutylammonium (TBA) salt of a hyaluronic acid; and conjugating the chlorinated ascorbic acid with the tetrabutylammonium (TBA) salt of the hyaluronic acid.

According to an exemplary embodiment of the present invention, the step of chlorinating the ascorbic acid may include dissolving the ascorbic acid in an acetic acid and reacting the ascorbic acid with a saturated hydrogen chloride gas to substitute a hydroxyl group of the ascorbic acid with a chloride group; removing the acetic acid; and dissolving the ascorbic acid substituted with the chloride group in water and acetone, and evaporating the dissolved ascorbic acid to remove the acetic acid additionally.

The reacting step of the ascorbic acid with the saturated hydrogen chloride gas may be performed for 10-20 hours. The step of chlorinating the ascorbic acid further includes recrystallizing the ascorbic acid substituted with the chloride group using a polar solvent to obtain the ascorbic acid substituted with the chloride group with a purity of 97-100% after the step of evaporating the dissolved ascorbic acid. In this case, the polar solvent may include nitromethane. Besides, the step of chlorinating the ascorbic acid further include additionally recrystallizing the ascorbic acid substituted with the chloride group using acetone after the step of recrystallizing the dissolved ascorbic acid.

According to exemplary embodiment of the present invention, the step of producing the tetrabutylammonium (TBA) salt may include flowing a tetrabutylammonium (TBA) aqueous solution into a cation-exchange resin to exchange a cation of the cation-exchange resin for a TBA ion dissociated in the TBA aqueous solution; and flowing a sodium salt aqueous solution of the hyaluronic acid into the cation-exchange resin to exchange the TBA ion for a sodium ion of the hyaluronic acid. In this case, the cation-exchange resin may include a weak acidic cation-exchange resin and the cation attached to the cation-exchange resin may include a sodium ion. In addition, the TBA aqueous solution flowed into the cation-exchange resin may have a concentration of 30-50% by weight.

According to another exemplary embodiment of the present invention, the step of conjugating the chlorinated ascorbic acid with the tetrabutylammonium (TBA) salt may includes dissolving the chlorinated ascorbic acid and the TBA salt of the hyaluronic acid into dimethyl sulfoxide (DMSO) with stirring to obtain the hyaluronic acid derivative; removing DMSO as the chlorinated ascorbic acid and the TBA salt of the hyaluronic acid disappear; and forming a solid of the hyaluronic acid derivative using water and acetone, filtering the solid, washing the solid using water, and drying the solid.

In this case, the step of dissolving the chlorinated ascorbic acid and the TBA salt of the hyaluronic acid may be performed under a temperature range of 50 to 90° C. for 30-70 hours. Also, the step of removing DMSO may include distilling the DMSO under a reduced pressure.

A hyaluronic acid derivative of the present invention may be synthesized by the processes as mentioned above.

### MODE OF THE INVENTION

The process of synthesizing a hyaluronic acid derivative according to an exemplary embodiment of the present invention comprises chlorinating an ascorbic acid to obtain a chlorinated ascorbic acid as a first step; producing a tetrabutylammonium (TBA) salt of a hyaluronic acid as a second step; and conjugating the chlorinated ascorbic acid with the tetrabutylammonium (TBA) salt of the hyaluronic acid as s third step. Referring to attached drawings, the exemplary embodiments of the present invention will be described in detail below.

Referring to appended drawings, the preferred embodiments of the invention will be described. The examples below will be modified to various forms, but the scope of the invention is not limited to such examples. The examples below are provided for only explaining to those skilled in the art.

First, the process of synthesizing hyaluronic acid derivative (CIB9001S) conjugated with ascorbic acid and the hyaluronic acid derivative according to an exemplary embodiment of the present invention will be described. Next, therapeutic effects against skin disorders such as atopic dermatitis and skin regeneration effect of the hyaluronic acid derivative of the present invention will be described.

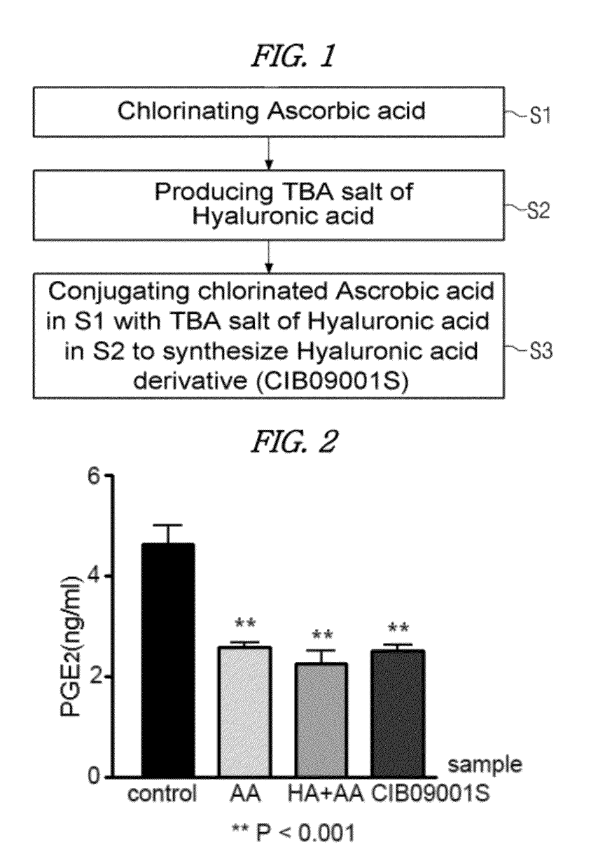

FIG. 1 is a diagram showing a process of a hyaluronic acid derivative according to an exemplary embodiment of the present invention.

Referring to FIG. 1, the process of synthesizing hyaluronic acid derivative can be classified into three steps. A first step is a step of chlorinating ascorbic acid, a second step is a step of producing tetrabutylammonium (hereinafter, referred to “TBA”) salt of hyaluronic acid, and a third step is a step of conjugating chlorinated ascorbic acid in the first step with TBA salt of hyaluronic acid so as to synthesize hyaluronic acid derivative (CIB09001S) as an end product and analyzing quantitatively the end product. Detailed process in each of the steps will be described in more detail below.

In the first step, prepared ascorbic acid is dissolved in acetic acid, and then saturated hydrogen chloride (HCl) gas is reacted with the ascorbic acid dissolved in acetic acid for 10-20 hours, preferably about 15 hours. As a result of this reaction, the hydroxyl group of the ascorbic acid is substituted with chloride group. The chlorination reaction of the ascorbic acid is shown in formula II below.

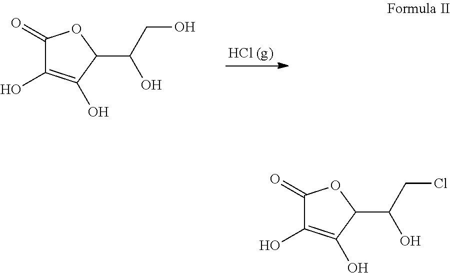

After the step of chlorination of the ascorbic acid, a step of obtaining a chlorinated ascorbic acid with high purity is followed. For obtaining high purity, the acetic acid as a solvent is removed. To begin, acetic acid is removed partly, and then additionally removed by repeating steps of dissolving acetic acid as a solvent into water and acetone and vaporizing acetic acid. In addition, chlorinated ascorbic acid without acetic acid is dissolved in nitromethane and then recrystallized. The recrystallizing step may be repeated about 10 times in order to obtain chlorinated ascorbic acid with a purity of 97% or more. Chlorinated ascorbic acid with high purity may be recrystallized additionally using acetone to obtain pure chlorinated ascorbic acid. The obtained chlorinated ascorbic acid may be verified by using Nuclear Magnetic Resonance (NMR) (S1).

In the second step, a weak acidic cation-exchange resin (Amberlite® IRC86) containing sodium ion (Na⁺) is filled onto a column. Next, enough amount of prepared TBA aqueous solution with a concentration of 30 to 50% by weight, preferably 40% by weight, is flowed into the cation-exchange resin, and then the resin is washed with water. By this step, TBA ion (TBA⁺) dissociated in the TBA aqueous solution may be exchanged for sodium ion (Na⁺) of the cation-exchange resin. Accordingly, it is possible to observe swelling.

Next, sodium salt of hyaluronic acid dissolved in water is flowed into the cation resin substituted with TBA ion according to the steps as mentioned above. TBA ion is detached from the cation-exchange resin, and then is exchanged for sodium ion (Na⁺) of sodium salt of hyaluronic acid through this step. As a result, it is possible to obtain TBA salt of hyaluronic acid.

A mechanism for obtaining TBA salt of hyaluronic acid is shown in formula III below: Wherein ‘HA-COONa’ means sodium salt of hyaluronic acid substituted hydrogen ion (H⁺) of hyaluronic acid with sodium ion (Na⁺) and ‘HA-COO⁻TBA⁺’ means TBA salt of hyaluronic acid substituted sodium ion with TBA ion.

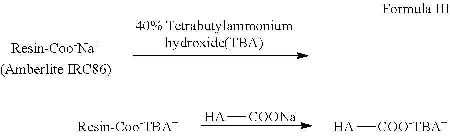

The third step is a step of conjugating a chlorinated ascorbic acid obtained in the first step with a TBA salt of hyaluronic acid obtained in the second step. In this step, both chlorinated ascorbic acid and TBA salt of hyaluronic acid is put into dimethyl sulfoxide (DMSO), system temperature is raised gradually, and then chlorinated ascorbic acid and TBA salt of hyaluronic acid is dissolved under a temperature range of 50 to 90° C. for 30-70 hours, preferably about 80° C. for about 48 hours, with stirring in order to synthesize hyaluronic acid derivative of the present invention.

DMSO as a solvent in this step may be removed by distillation under pressure as the TBA salt of hyaluronic acid and the chlorinated ascorbic acid as a staring material disappear using thin layer chromatography (TLC). And then, forming and filtering solid using water and acetone.

The solid may be washed several times with water and dried in a vacuum desiccator. As a result, hyaluronic acid derivative (CIB090001S) as an end product of the present invention is synthesized. The derivative may be analyzed quantitatively high speed liquid chromatography (HPLC).

Conjugation mechanism between the TBA salt of hyaluronic acid and the chlorinated ascorbic acid is shown in formula IV below:

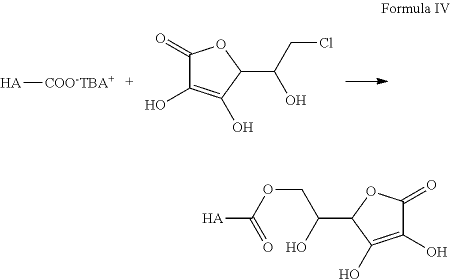

A more detailed chemical structure of the hyaluronic acid derivative of the present invention, which is the product in formula IV, is shown in formula V below:

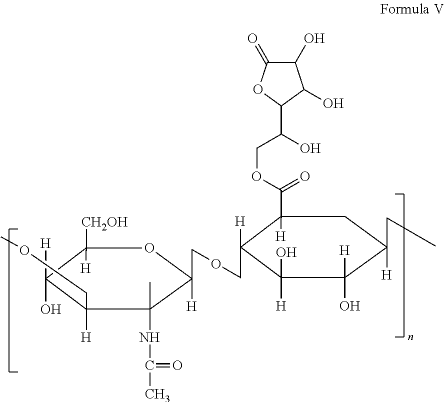

Next, effects of hyaluronic acid derivative (herein after ‘CIB09001S’) will be described.

### Experiment Example 1

We measured PGE₂ level suppressed by CIB09001S in cellular level in experiment example 1. As a positive control, ascorbic acid (AA) and a mixture of hyaluronic acid and ascorbic acid (HA+AA) was used in this Example. PGE₂ is a substance causing inflammation, edema, pain and fever in body.

Microphage cell-line (RAW 264.7) was inoculated into medium containing DMEM (Dulbecco's modified Eagle's medium)/FBS (Fetal Bovine Serum) under a condition of 75% of CO₂ concentration at a temperature of 37° C. in order to culture the cell-line. The cultured medium was separated into each well in the concentration of 1×10⁵ (cells/mL), respectively, and then the separated medium was cultured additionally for 16 hours to stabilize cells and to manufacture complete culture media for following experiments.

500 ng/ml of lipopolysaccharide (LPS) was added into each of the complete media to cause PGE₂ to increase in cells, and then each of 10 mg/ml of CIB09001S, 10 mg/mL of AA and 10 mg/ml of HA+AA was added into the medium, respectively.

The complete medium was cultured additionally for 24 hours, and then PGE₂ level in supernatant of medium was assayed by ELISA (enzyme-linked Immunosorbent Assay) analysis.

ELISA analysis was performed using ELISA kit (R&D System) by adding 100 μL of the medium supernatant, 100 μL of PEG₂ as a standard, and 50 μL of primary antibody to a prepared microplate, and then each well was placed at room temperature for 2 hours. Each well was washed, and then substrate solution was added. The solution was placed at room temperature for 30 minutes, and then coupling reaction was observed as optical density (OD) at 450 nm using ELISA reader.

FIG. 2 is a graph showing of the result of this Example. In FIG. 2, significance test of each value was tested using Student's test; and P means P-value.

Referring to FIG. 2, LPS causes PGE₂ to increase; CIB09001S, AA and HA+AA decrease PGE2 significantly compared to control. Accordingly, it is certified that CIB09001S is effective for alleviating skin disorders, edema and pain.

### Experiment Example 2

In this Example, we measured TNF-α level suppressed by CIB09001S in cellular level. Complete cell-cultured media, and types and contents of the negative control and positive control were identical with Example 1. TNF-α is a kind of inflammatory cytokine as a biological response-regulating molecule with carcinostatic effect and has an important role in innate immunity. The concentration of TNF-α rises as concentrations of inflammatory substance rise.

The culturing procedures and treating procedures are the same as the above Example 1. TNF-α level in supernatant of medium was assayed by ELISA analysis using CIB09001S, AA and HA+AA with the same concentration as the Example 1.

1 μg/mL of anti-human TNF-α antibody (monoclonal antibody against TNF-α) was diluted with PBS (phosphate buffered saline, pH 7.4), 100 μL of the antibody was coated onto each well of 96-well plate, and then each well was placed at room temperature for 16 hours. The plate was washed with PBS containing 0.05% tween, and then blocked with PBS containing 1% of BSA (bovine serum albumin). After washing several times, medium supernatant and recombinant TNF-α as a standard was added onto each well, and then each well was placed again at room temperature for 2 hours.

After washing each well, TNF-α conjugated with biotin as a secondary antibody was added, and then each well was placed at room temperature for 2 hours. After washing each well several times, avidine-attaching hydrogen peroxide was added onto each well, and then the solution was placed at room temperature for 30 minutes. After washing each well, ABTS [2,2′-azino-bis(3-ethylbenzthiazoli-6-sulfonic acid] as a substrate was added onto each well, and then coupling reaction was observed as optical density (OD) at 405 nm using ELISA reader.

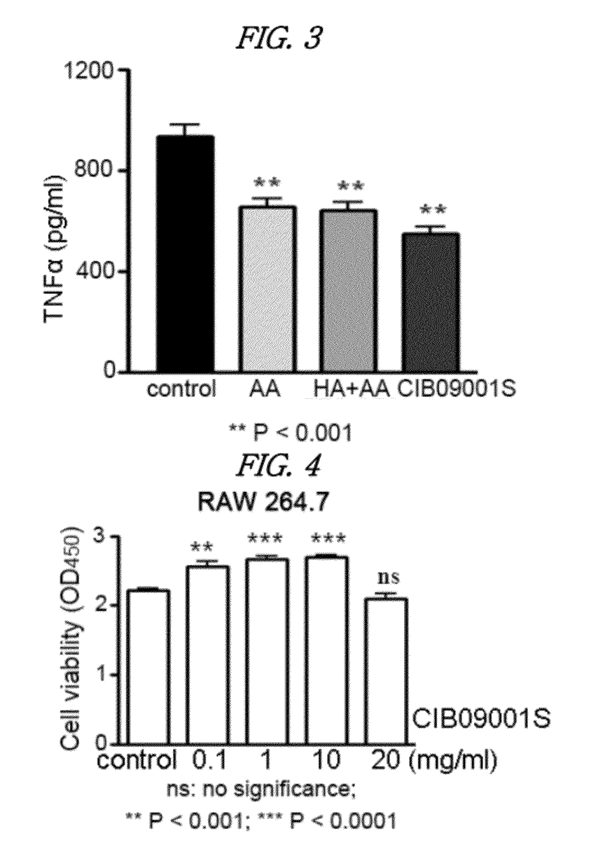

FIG. 3 is a graph showing of the result of this example. In FIG. 3, significance test of each value and P's meaning is the same as in FIG. 2

Referring to FIG. 3, like positive control group, CIB09001S group decrease significantly TNF-α level induced by LPS compared to negative control group. Accordingly, it is certified that CIB09001S is effective for reducing inflammatory substances.

### Experiment Example 3

In this Example, we measured cytotoxicity induced by CIB09001S levels.

In order to determine cytotoxicity and cell viability induced by CIB09001S, WST-1 assay was used. WST-1 assay uses phenomenon of conversion and reduction of yellowish water-soluble substance tetrazolium salt “WST-1” by succinate dehydrogenase in mitochondria of living cell or mitochondrial dehydrogenase into pigment formazan.

Three cell-lines, mouse macrophage cell-line RAW 264.7, mouse fibroblast cell-line BALB 3/T3 and mouse osteoblast cell-line MC3T3-E1 were used. Each cell-line (1×10⁴ cell/mL) was inoculated onto 96-well plate, and then cultured on DMEM/FBS medium.

After culturing for 16 hours, CIB09001S (0.1, 1, 10 and 20 mg/mL) was added onto the cultured medium, and then the plate was placed 24 hours on the condition of 5% CO₂ concentration and at a temperature of 37° C. After removing supernatant, 200 μL of PBS was added onto each well in order to wash the plate, and then solution containing 100 μL of DMEM and 10 μL of WST-1 was added onto each well. After 4 hours, Optical density at 450 nm was measured for each well.

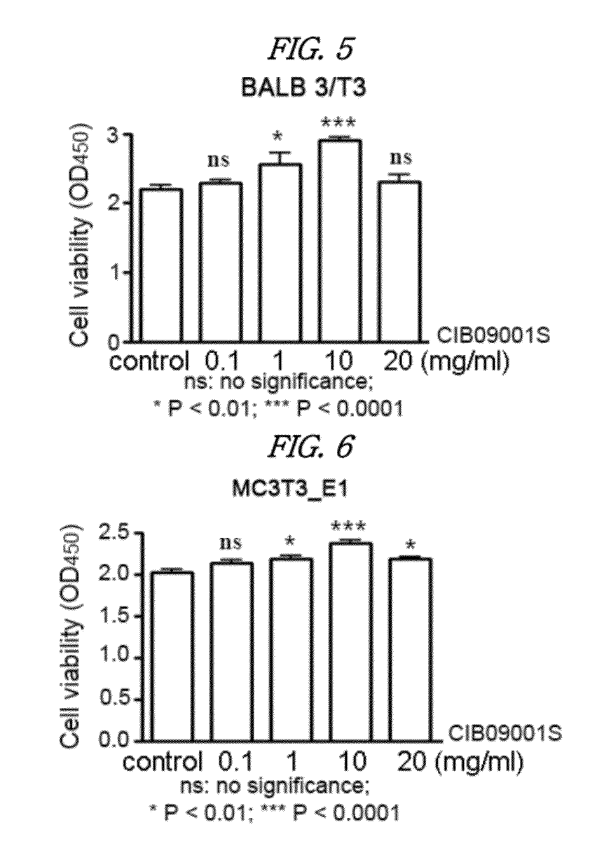

FIGS. 4 to 6 are graph showing measuring results of this example. FIG. 4 shows a measuring result on RAW 264.7 cell; FIG. 5 shows a measuring result on BALB 3/T3 cell; and FIG. 6 shows a measuring result on MC3T3 E1. In FIGS. 4 to 6, significance test of each value and P's meaning is the same as in FIG. 2, and ‘ns’ means not-significant.

Referring to FIGS. 4 to 6, CIB09001S does not show any cytotoxicity on all cell lines like the negative control group. Accordingly, it is certified that CIB09001S can be applied to pharmaceuticals or cosmetics.

### Experiment Example 4

In this Example, we measured if CIB09001S can be effective to atopic dermatitis as an example of skin disorder. Each of hyaluronic acid and hydrocortisone was used as a positive control.

As in vivo experiments, this example was performed using mouse model (5 weeks; body weight 22-24 g; Nc/Nga) having skin inflammation induced by atopic inducer 2,4-dinitrochlorobenzene (DNCB). The mouse model has similar atopic lesions as human.

DNCB was dissolved in substance containing acetone and oil with a ratio of 3:1 so as to prepare initial solution containing DNCB in the concentration of 1% by weight. 10 μL of the initial solution was applied to both ears of each mouse three times a week for 40 days to induce atopic lesions.

After the DNCB treatment, 10 mg/mL of CIB09001S was applied to the ears of atopy-induced mouse everyday. In addition, 10 mg/mL of hyaluronic acid or 10 mg/mL of hydrocortisone was applied to the ears of atopy-induced mouse everyday as a positive control. We checked right ear thickness of each mouse three times a week during DNCB treatment and everyday during CIB090001 treatment.

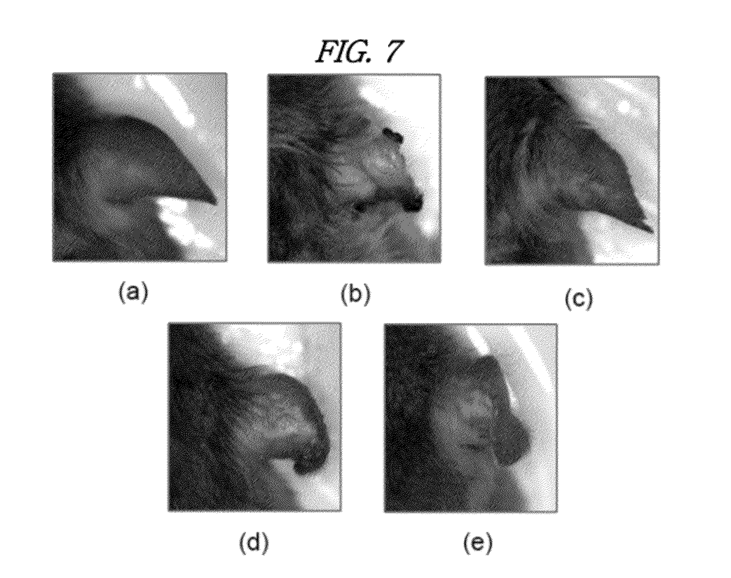

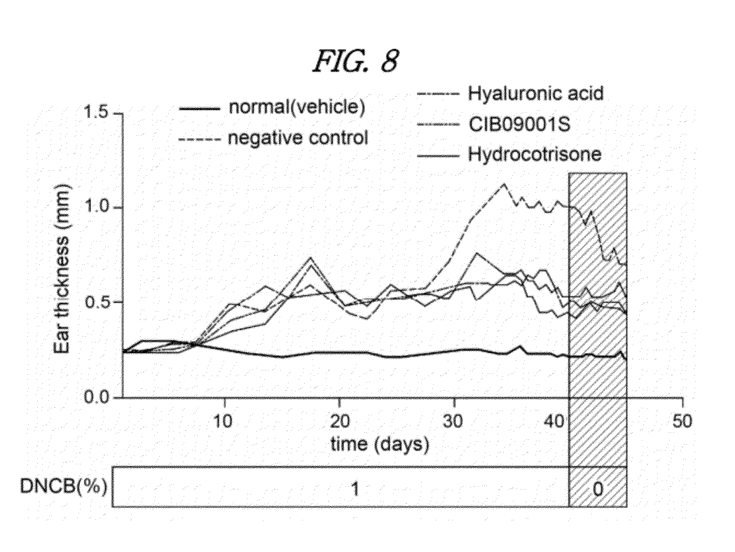

FIG. 7 is a photograph showing mice's ears according to this example, and FIG. 8 is a graph showing a measuring result for each mouse's ear thickness according to this Example. In FIG. 7, (a) shows a normal mouse ear without atopic lesions; (b) shows an atopy-inducing mouse ear as a negative control without any further treatment; (c) shows a hydrocortisone-treating mouse ear as a positive control group; (d) shows a hyaluronic acid-treating mouse ear as a positive control group; and (e) shows a hyaluronic acid derivative, CIB09001S-treating mouse ear.

Referring to FIGS. 7 and 8, CIB09001S as well as the positive control can reduce ear thickness significantly compared to the negative control. With regard to reducing effect of atopic dermatitis as an exemplary skin disorder, there are no statistically significant differences among CIB09001S and the positive controls.

### Experiment Example 5

In this Example, we checked CIB09001S efficiency for skin regeneration. As a positive control, a skin section treated with the same concentration of hyaluronic acid (HA) with same concentration as CIB09001S was used. As a negative control, a skin section treated only phosphate buffered saline (PBS) was used.

After inducing injury on back of hairless mice (5 weeks) using a bioptic punch (Φ5 mm), each of 10 mg/mL of CIB09001S and 10 mg/mL of hyaluronic acid was treated to the affected area for 10 days while observing skin conditions.

After treating with CIB09001S, skin tissues around the affected area were biopsied, and then fixed to 10% of formaldehyde solution. The fixed skin tissues were immersed in paraffin to cut the skin tissue Skin tissue sections were attached to each slide glass, and then stained to observe skin tissue with microscope. In order to stain the tissue sections, HE staining method (Haematoxylin-Erosion Staining) and Masson's trichrome stating method were used.

In order to determine collagen-synthesis efficacy of the regenerated tissue, contents of hydroxyproline was determined as follows. In order to hydrolyze hydroxyproline as a standard for the mouse tissue section, hydroxyproline was dissolved in 2N sodium hydroxide (NaOH), and then autoclaved at 120° C. for 20 minutes. Next, 405 μL of chloramine-T was added to this solution, and then the solution was placed at room temperature for 25 minutes. 500 μL of Ehrilch's aldehyde was added, and then reacted with the solution at 65° C. for 20 minutes to induce coupling. After coupling, we measured optical density at 550 nm.

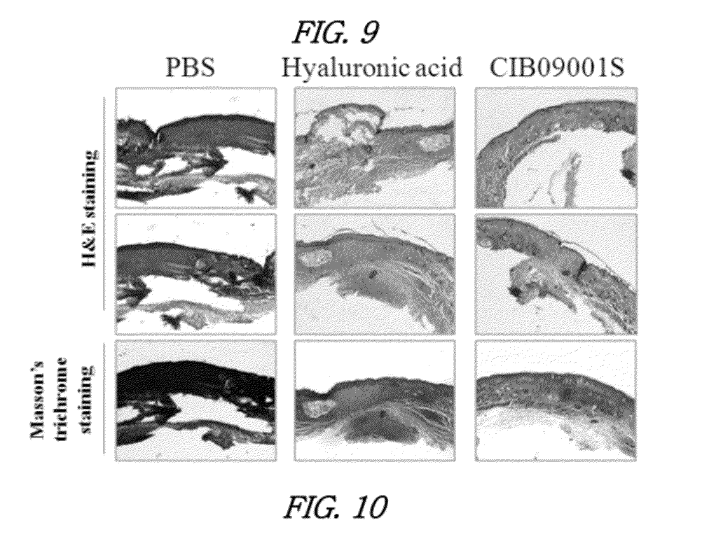

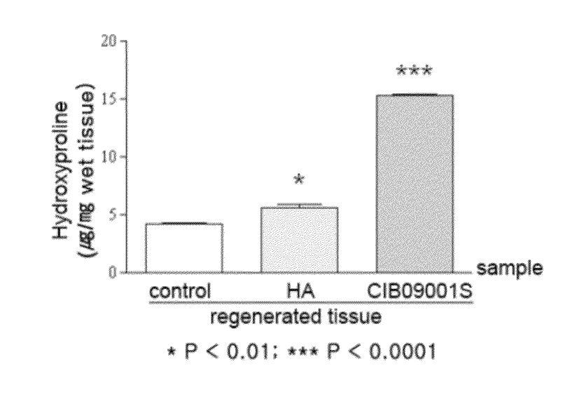

FIG. 9 is photomicrograph showing mice's skin tissue sections according to this example; and FIG. 10 is a graph showing contents of hydroxyproline for determining collagen synthetic efficacy in this example.

Referring to FIG. 9, both CIB09001S-treating group and hyaluronic acid-treating positive control group show superior skin regeneration efficiency compared to group treating only PBS. Particularly, CIB09001S-treating group shows better skin regeneration efficiency that hyaluronic acid-treating group.

In addition, referring to FIG. 10, both CIB09001S-treating group and hyaluronic acid-treating positive group have higher level of hydroxyproline compared to the negative control group. Especially, CIB09001S-treating group shows highly raised level of hydroxyproline than the positive control group. These results show that CIB09001S of a hyaluronic acid derivative is effective for skin regeneration, i.e., has an excellent effect on collagen synthesis.

It will be apparent to those skilled in the art that various modifications and variations can be made in the present invention without departing from the spirit or scope of the invention. Thus, it is not intended that the scope of the invention is limited to the exemplary embodiments above. In other words, the exemplary embodiments described above are only provided to those skilled in the art in order to fully explain the present invention. For example, those skilled in the art can remove the solvent differently in chlorinating ascorbic acid. Also, in the course of producing TBA salt of hyaluronic acid, hydrogen ion (H⁺) or ammonium ion (NH⁺) as an exchange ion attached to the cation-exchange resin may be used instead of the sodium ion (Na⁺).

### INDUSTRIAL APPLICABILITY

The hyaluronic acid of the present invention can be utilized as an active ingredient in drugs or cosmetics for effective in skin regeneration or atopic dermatitis treatment.

1. A process of synthesizing a hyaluronic acid derivative, the process comprising:
chlorinating an ascorbic acid to obtain a chlorinated ascorbic acid;
producing a tetrabutylammonium (TBA) salt of a hyaluronic acid; and
conjugating the chlorinated ascorbic acid with the tetrabutylammonium (TBA) salt of the hyaluronic acid.

2. The process according to claim 1, wherein the step of chlorinating the ascorbic acid includes dissolving the ascorbic acid in an acetic acid and reacting the ascorbic acid with a saturated hydrogen chloride gas to substitute a hydroxyl group of the ascorbic acid with a chloride group; removing the acetic acid partly; and dissolving the ascorbic acid substituted with the chloride group in water and acetone, and evaporating the dissolved ascorbic acid to remove the acetic acid additionally.

3. The process according to claim 2, wherein the step of reacting the ascorbic acid with the saturated hydrogen chloride gas is performed for 10-20 hours.

4. The process according to claim 2, wherein the step of chlorinating the ascorbic acid further including recrystallizing the ascorbic acid substituted with the chloride group using a polar solvent to obtain the ascorbic acid substituted with the chloride group with a purity of 97-100% after the step of evaporating the dissolved ascorbic acid.

5. The process according to claim 4, wherein the polar solvent includes nitromethane.

6. The process according to claim 4, wherein the step of chlorinating the ascorbic acid further including additionally recrystallizing the ascorbic acid substituted with the chloride group using acetone after the step of recrystallizing the dissolved ascorbic acid.

7. The process according to claim 1, wherein the step of producing the tetrabutylammonium (TBA) salt includes flowing a tetrabutylammonium (TBA) aqueous solution into a cation-exchange resin to exchange a cation of the cation-exchange resin for a TBA ion dissociated in the TBA aqueous solution; and flowing a sodium salt aqueous solution of the hyaluronic acid into the cation-exchange resin to exchange the TBA ion for a sodium ion of the hyaluronic acid.

8. The process according to claim 7, wherein the cation-exchange resin includes a weak acidic cation-exchange resin and the cation attached to the cation-exchange resin includes a sodium ion.

9. The process according to claim 7, wherein the TBA aqueous solution flowed into the cation-exchange resin has a concentration of 30-50% by weight.

10. The process according to claim 1, wherein the step of conjugating the chlorinated ascorbic acid with the tetrabutylammonium (TBA) salt includes dissolving the chlorinated ascorbic acid and the TBA salt of the hyaluronic acid into dimethyl sulfoxide (DMSO) with stirring to obtain the hyaluronic acid derivative; removing DMSO as the chlorinated ascorbic acid and the TBA salt of the hyaluronic acid disappears; and forming a solid of the hyaluronic acid derivative using water and acetone, filtering the solid, washing the solid using water, and drying the solid.

11. The process according to claim 10, wherein the step of dissolving the chlorinated ascorbic acid and the TBA salt of the hyaluronic acid is performed under a temperature range of 50 to 90° C. for 30-70 hours.

12. The process according to claim 10, wherein the step of removing DMSO includes distilling the DMSO under a reduced pressure.

13. A hyaluronic acid derivative of formula (V) below, wherein the derivative is synthesized by the process according to claim 1: 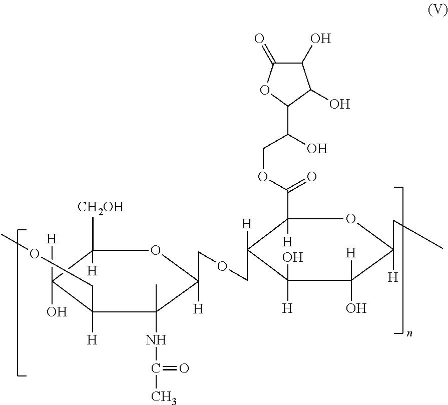
Wherein n is an integer of 1 or more.
